(19) United States
(12) Patent Application Publication
(10) Pub. No.: US 2021/0272473 A1
(43) Pub. Date: Sep. 2, 2021

(54) Arrangement For Providing At Least One User With Tailored Cybersecurity Training

(71) Applicant: RONA FINLAND OY, HELSINKI (FI)

(72) Inventors: Zeljko BOSKOVIC, HELSINKI (FI); Oskari RAISANEN, HELSINKI (FI)

(21) Appl. No.: 17/290,902

(22) PCT Filed: Nov. 1, 2019
(86) PCT No.: PCT/FI2019/050779

§ 371 Date: May 3, 2021

(30) Foreign Application Priority Data
Nov. 1, 2018 (FI) 20185924

(51) Int. Cl. G09B 19/00; G09B 5/06; G06Q 50/20; G06F 21/57

(52) U.S. Cl. CPC G09B 19/0053; G06F 21/57; G06Q 50/20; G09B 5/065

(57) ABSTRACT

An electronic arrangement (101) for providing a number of organizations with tailored cybersecurity training, a number of users being associated with an organization and each of the number of users being further associated with an electronic user device (106), the arrangement comprising a data interface (134) and at least one processor (102) that is configured, in accordance with instructions (136) stored in a memory (138) accessible to the at least one processor, to receive asset information (104) related to a plurality of digital assets that are available for use for one or more users of said number of users associated with the organization, and preferably for each user of said number of users associated with the organization: receive user information (108) related to a user, determine, based on the received information (104, 08, 110), at least one risk factor that is indicative of a cybersecurity risk related to use of at least one of the digital assets, determine, based on the received information, the relevancy of the at least one risk factor and/or associated at least one digital asset to the user, and based on the determined relevance, provide the user with cybersecurity training (106a) targeting the cybersecurity risk via the electronic user device.

### TECHNICAL FIELD OF THE INVENTION

The present invention generally relates to digital devices, networks and applications running therein. Particularly, however not exclusively, the invention relates to provision of tailored dynamic cybersecurity training to individuals working or otherwise acting in different organizations such as corporations, public entities, or communities.

### BACKGROUND OF THE INVENTION

Cybersecurity is a crucial concept that e.g. corporations as well as private users should consider. Cybersecurity, or data security, may be compromised by cyberattacks or data breaches, and considerable large risks are associated especially with users of digital assets. User risks may be related to acts performed or omitted by the user, such as acts of carelessness, for instance not closing an application or exiting a session after use of a digital asset where vulnerable information is handled (e.g. internet banking). User-associated risks or liabilities may also include or be induced through e.g. the type of user device (type of device and operating system) or type of digital asset in use (such as version of software).

Organizations such as companies and private users are using increasing amounts of different digital assets. With more and more digital assets or services in use, cybersecurity risks are also increasing due to a so-called larger attack surface area. The digital services in use originate from various sources and it may be difficult to keep track with security risks or threats that are associated with them.

In the case of companies, for instance, digital services from various sources may be in use, and various types of users (e.g. employees having different roles), user devices, and nature of the use may be employed. Some of the digital services may be provided from in-house servers whereas some others are offered by servers located outside corporate premises or server centers, e.g. from a cloud. Users (corporate workforce and/or temporary workforce) commonly access the necessary digital services via their desktop personal computers and/or laptops and/or mobile devices.

Accordingly, some of the digital services may be accessed by the user via internet browser or other generic application, while some require a more dedicated local component such as dedicated client application installed on users' computers, laptops, or mobile devices.

From the standpoint of physical presence, the digital services may also be used while users are located within corporate premises especially in connection with ordinary office workers, or the services may be accessed from more or less public places considering e.g. mobile workforce. For example, police officers are equipped with mobile devices providing them with access to numerous digital services related to their work.

Effects of cyberattacks are usually loss of productivity, unauthorized access of confidential data, or unauthorized access to intellectual property, all creating significant material cost and/or lost competitive advantages.

Corporations and other large organizations are making significant investments in protecting corporate networks from unauthorized access and other cyberattacks. Corporations are utilizing technology and additional services to protecting access to their networks. Computer programs and physical devices, with reference to e.g. so-called firewalls, may be used for preventing unauthorized access to networks. Computer programs and 3^{rd} party services (i.e. antivirus software) can also be used to protect endpoints (e.g. the aforementioned user PCs, laptops and mobile devices) and intermediate devices. Still, regardless of various defensive measures potentially taken by companies and other organizations, cybersecurity incidents are occurring frighteningly frequently in the form of access of unauthorized data, installing malicious software such as viruses or blackmailing software, and other forms of attacks. User endpoints provide numerous applications and ever more complex operating systems (Microsoft Windows, OS X, Android, iOS, etc. to name a few), leading to ever more increasing risks.

Some companies arrange cybersecurity training type events for employees but theses training may be generic, one time exercises and not related to a particular digital asset or be particularly relevant to an individual. Lectures etc. may be left unattended or listeners may not pay attention, while it is also difficult to know which type of training should be arranged at a particular instance in time.

For instance, at the time of a security breach, employees/users may not have the necessary training or information on hand to act as they should in the situation and it may not be possible for an organization to arrange such training, if they have even become aware of such an incident.

### SUMMARY OF THE INVENTION

An object of the invention is to alleviate at least some of the problems relating to the known prior art. The object of the invention can be achieved by the features of the independent claims. One embodiment of the present invention provides an electronic arrangement comprising e.g. a number of at least functionally connected servers optionally located in a cloud computing environment, for providing at least one user such as a corporate or company employee, public servant or club member with tailored cybersecurity training, the arrangement comprising at least one processor that is configured to execute activities as defined in the appended claim 1.

There is also provided a substantially corresponding method according to an appended independent method claim to be performed by electronic device or arrangement (e.g. system of functionally connected devices such as servers and/or other devices such as user devices).

Having regard to the utility of various embodiments of the present invention, tailored cybersecurity training may be provided for each user of e.g. a considered organization based on context, near real-time information on user exposure to particular security threats, and/or corporate (organization) risk level among other potential factors. This may result in reducing the probability of cyberattacks and decreased negative consequences thereof. Thus, assets such as confidential data and/or intellectual property may be kept more secure. Additionally or alternatively, loss of productivity, material costs, and/or competitive advantages may be avoided or at least minimized.

As different standards and legislation may set requirements for cybersecurity within organizations in their activities, various embodiments of the present invention may facilitate reaching the required level of security and knowledge among users, with reference to e.g. ISO/IEC 27001 and 27002, where ISO/IEC 27001 formally specifies a management system that is intended to bring information security under explicit management control, and SO/IEC 27002 incorporating part of the BS 7799 good security management practice standard, or The NIST Cybersecurity Framework (NIST CSF) defining “a high level taxonomy of cybersecurity outcomes and a methodology to assess and manage those outcomes.”

Through various embodiments of the invention, information regarding one or more of the digital assets that may be used by an individual is cleverly and preferably more or less automatically obtained by the executing arrangement, and an individual or organization does not have to separately retrieve and analyze data from a number of sources to gain knowledge on cybersecurity issues that are related to the digital assets in use.

In various embodiments, an arrangement and related method as suggested herein may utilize obtained information related to digital services/assets hosted within a corporate network, 3^{rd} party services, additional threat level services, data from the dark web, location data, user data, and/or data from devices (endpoints, electronic devices) used by users. This data may be utilized in determining the at least one risk factor associated with each digital asset, for instance. The data concerning various organizations and emerging various sources, even outside the organizations such as from the aforementioned dark web, ordinary web sites, discussion forums, social media sites and/or other network based sources, may be exploited in determining aspects such as risk factors regarding a certain organization or certain user within the organization.

In various embodiments, tailored cybersecurity training may comprise cybersecurity data training elements that are preferably provided to a user in a determined order, the cybersecurity data training elements and e.g. their specific order being called here a training payload. A training element may be associated with one or more cybersecurity (user) risks. For example, if a training element involves password change, the associated risks may include password expiration or staticity, or breach type risks.

The cybersecurity data training elements in a training payload may be selected from a group a group of cybersecurity data training elements using the obtained information, advantageously the at least one determined risk factor.

In various embodiments, user information is obtained. The user information may be used in determining of the at least one risk factor. User information may comprise information related to one or more devices that may be used by the user, access rights that the user has relating to the digital assets in their use (or, for instance in the case of a corporation, an employee status, which may indicate the level of access rights), etc.

A digital asset may be associated with one or more cybersecurity (user) risks. The risks may be related to behavior of a user or may be user-associated through e.g. type of device used by the user and/or location where the user is using the device. Through received user information, relevant risks that are related to an individual user may be taken into account and may be used to determine the at least one risk factor. A risk may be of binary type (it is or is not relevant to an asset). A user risk may be alternatively or additionally associated with a finer scale of values as explained below.

The at least one determined risk factor may in an embodiment comprise a user risk index that is determined using obtained user information that is indicative of different types of user risks that are associated with an individual user e.g. via a digital asset the user uses or is at least entitled to use in terms of access, for instance. The user risk index (URI) may be set to an initial value and updated upon receiving additional and/or updated information. In various embodiments, a user risk may be assigned a value (e.g. numerical value within a selected range, e.g. 0-1 with selected resolution) so that the (overall) user risk index may be determined based on the values of constituent user risks. For example, the URI may be assigned a value based on values of constituent user risks, optionally arithmetic mean, weighted mean, maximum, minimum or median thereof.

In various embodiments of the invention, the at least one determined risk factor may be indicative of an overall or organization (level) digital asset risk or risk index (CR, corporate risk) of e.g. a company or other entity, taking into account the plurality of digital assets associated therewith. The overall risk may be set to an initial value and updated upon receiving additional and/or updated information.

In various embodiments, the at least one determined risk factor may comprise a digital asset risk index that is determined for each digital asset through the information received. For instance, the digital asset risk index may be set to an initial value and updated upon receiving additional and/or updated information. For example, the index may be set and/or updated based on at least one element selected from the group consisting of: predefined selection, type of asset such as type of related digital service, user risk associated with the asset, value of user risk associated with the asset, type of user risk associated with the asset, asset version and vulnerability data.

As cybersecurity training may be provided that is relevant to a user, it may be more likely that the training will be useful and that the user may be interested in completing the training. The training may also be provided at a time that is relevant, e.g. once a security breach has occurred. The impact of the training may thus be larger.

The cybersecurity training may be provided automatically to a user according to predetermined criteria. The predetermined criteria may be related to a change occurring in the at least one determined risk factor. For instance, information may be received that indicates a newly exposed vulnerability related to a digital asset. This may result in a change in the determined risk factor for the digital asset. This change may result in a change in the training payload and cybersecurity training that is provided to a user. This change may also trigger automatic delivery of the cybersecurity training. For instance, the training may be pushed to a user device.

The cybersecurity training elements may comprise for instance a picture, photo, or video that should be viewed and/or a text that should be read to complete the training. Cybersecurity training elements may additionally or alternatively comprise instructions regarding procedures that should be taken by the user to complete the training.

For instance, in the case that a data breach has occurred, cybersecurity training may be automatically delivered to relevant users, where the users are instructed to change their password.

Through various embodiments of the invention, the tailored cybersecurity training may be provided to a user via a plurality of different types of user devices, e.g. computers, tablet computers, mobile phones, etc.

Various embodiments of the invention may be utilized to provide cybersecurity training for instance to individuals of various different organizations, such as employees of different corporations. The data may be advantageously obtained anonymously, so that organizations or individuals within an organization may not be individualized.

The exemplary embodiments presented in this text are not to be interpreted to pose limitations to the applicability of the appended claims. The verb “to comprise” is used in this text as an open limitation that does not exclude the existence of unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

The previously presented considerations concerning the various embodiments of the arrangement may be flexibly applied to the embodiments of the method mutatis mutandis, and vice versa, as being appreciated by a skilled person.

### BRIEF DESCRIPTION OF THE DRAWINGS

Next the invention will be described in greater detail with reference to exemplary embodiments in accordance with the accompanying drawings, in which:

FIG. 1 generally depicts an arrangement according to an embodiment of the invention.

FIG. 2 illustrates an embodiment of the arrangement and potential internals thereof in more detail.

FIG. 3 illustrates an embodiment of modelling the relationship between digital assets and user risks.

FIG. 4 illustrates an embodiment of the arrangement from the standpoint of serving a number of clients (trained organizations).

FIG. 5 is a flow diagram regarding an embodiment of a method in accordance with the present invention.

FIG. 6 is a flow diagram of an embodiment of cybersecurity training delivery process towards users (e.g. employees) of a target organization.

FIG. 7 depicts high-level examples of user interfaces (UI) the training arrangement or related client software may provide in a user device.

### DETAILED DESCRIPTION

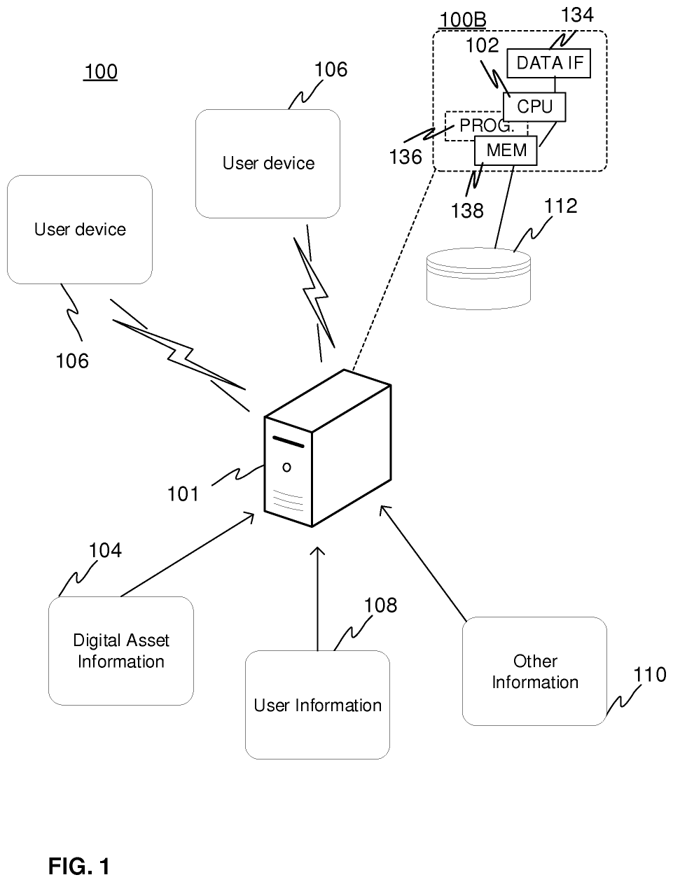

FIG. 1 shows, at 100, an exemplary electronic arrangement 101 according to an embodiment of the invention. The arrangement 101 may comprise one or more electronic devices such as servers and/or other devices at least functionally such as communications-wise connected together. Accordingly, the arrangement 101 may be realized as a system comprising multiple at least functionally connected electronic devices.

In terms of hardware, see sub-view at 1008, the arrangement 101 may comprise at least one processing unit 102 such as a microprocessor, microcontroller and/or a digital signal processor. The processing unit 102 may be configured to execute instructions embodied in a form of computer software 136 stored in a memory 138, which may refer to one or more memory chips, for example, separate or integral with the processing unit 102 and/or other elements. The memory 138 may store various further data in addition to mere program instructions. It may, for example, host a number of data repositories 112 such as databases accommodating information such as user information, digital asset information, further organization-related information and/or other information. Memory 138 such as selected data repositories or specifically databases may be physically distributed over a number of devices and/or systems, e.g. cloud computing or storage platforms.

The software 136 may define one or more applications for executing the activities described herein. A computer program product comprising the appropriate software code means may be provided. It may be embodied in a non-transitory carrier medium such as a memory card, an optical disc or a USB (Universal Serial Bus) stick, for example. The software could also be transferred as a signal or combination of signals wired or wirelessly from a transmitting element to a receiving element.

Item 134 refers to one or more data interfaces such as wired network and/or wireless network interfaces, or in practice network adapters, for providing communication capability to the arrangement 120 to exchange data with external systems including e.g. electronic systems of target organizations (client organizations to be trained by the arrangement 101), user devices and other externals systems/devices. The associated data transfer may include data reception and/or transmission as being clear to a person skilled in the art. The communication may take place directly or via intermediate entities such as networks, e.g. the internet and/or cellular networks. A UI (user interface) such as a web-based UI, a native client based UI, and/or other remote UI to be discussed also hereinlater may be provided and optionally at least partially implemented by means of the interface 134.

In various embodiments of the present invention, desired information/data may be generally transferred between the arrangement 101 and various other entities (from and/or to the arrangement 101) such as user devices, systems of target organizations, software, service or hardware providers, and other potential systems or entities such as a number of selected web sites, web pages, deep or specifically dark web entities or other overlay networks, etc. using a suitable data interface 134 including e.g. wired and/or wireless network connections over the internet and/or other networks.

Data may be received from different sources through fetching or pulling procedures wherein the arrangement may have been provided a direct access to external data source or the data source has responded to a specific data query by the arrangement, and/or the data may be received based on autonomous (e.g. trigger based or scheduled) transmission actions by the sending parties. It is further possible that information is delivered non-digitally or at least excluding e.g. a network or similar connection between the arrangement 101 and external system. For example, information may be provided on a portable medium such as digital medium (e.g. memory card or stick) or non-digital medium, e.g. on paper, so that it is at least partially manually input in the arrangement 101 by the operator of the arrangement 101, for example.

In various embodiments, the information/data may be dynamically supplemented or updated based on e.g. triggers (e.g. updated data coming available e.g. in a system of a target organization or other external environment may trigger sending a related notification to the arrangement 101) and/or scheduling (the arrangement 101 may be configured to request update information from selected sources in a regular or otherwise scheduled fashion, for example).

In various embodiments, the arrangement 101 may then be configured to process (filter, enrich, aggregate, combine, etc.) the available information as being also described in more detail hereinafter.

In terms of preferred data acquisition, the arrangement 101 may be configured to receive digital asset information 104, this information being indicative of a number of, preferably of substantially all, digital assets that are generally used in a target organization. An asset may represent e.g. software, an application and/or service that may be used e.g. by one or more users in the organization, such as an employee of a company, through user device 106 and/or otherwise.

As alluded to above concerning communication and information/data transfer more generally between the arrangement 101 and external systems, devices or other entities, the digital asset information 104 may be received from a number of sources. At least some of the digital asset information 104 may be received from e.g. a target organization, associated user, a 3^{rd} party source offering the digital asset (e.g. application, hardware or service provider), a deep web source, and/or some other external source.

The user devices 106 may comprise electronic devices such as a mobile phone, PC, laptop, or tablet computer among other options. Also the user devices 106 just like the arrangement 101 may comprise, with reference to sub-view 1008, the necessary processing unit(s), memory and communication adapter(s) for performing actions, storing data and interfacing with external devices or systems such as the arrangement 101. A user may be associated with one or more user devices 106. Likely each user is exclusively associated with at least one user device such as a terminal device of some sort (e.g. personal computer, smartphone/mobile terminal, etc.). Indication of such association may further be received by the arrangement 101, typically from the system of the concerned target organization and/or from the user (device) itself. For example, a user ID may be linked with a device ID in the data stored by the arrangement. The linkage data may be received from the organization of the user, for example.

Returning to the topic of digital asset information 104, in a rather typical embodiment, the arrangement 100 is indeed utilized to serve an organization and a plurality of users thereof in terms of cybersecurity and related training and optionally optimization activities. The digital asset information 104 may thus comprise information regarding and advantageously specifying (identifying and/or qualifying in terms of information security, for example) some, most or preferably all the digital assets that are in use in the organization, such as a company.

The digital asset information 104 may, for instance, indicate at least one element regarding an asset, a plurality of assets, or the IT system used in a target organization, selected from the group consisting of: application ID, type and/or settings, software ID, type and/or settings, service ID, type and/or settings, network service ID, type and/or settings, version, software version, hardware version, hardware, hardware element, router, server, file server, cloud platform, connectivity, network connections, third party application, third party service, type of asset (in-house or 3^{rd} party, for example), accessibility, firewall, firewall settings, software version, hardware version, IT infrastructure, network infrastructure, and intranet.

Yet, the digital asset information 104 may comprise cybersecurity vulnerability data such as risk information regarding the asset from the standpoint of a user (e.g. type and/or other characterization of risk that is possible to realize with the asset, e.g. password breach). For example, the digital asset information 104 may comprise information indicating the types of user risks that may be associated with the digital asset.

Alternatively or additionally, the arrangement 101 may comprise data indicative of a number of different cybersecurity (user) risks that are associated, by the arrangement 101, with a selected organization based on the information obtained on the digital assets of the organization. For example, with certain specific asset or asset type, there may be some known risks associated therewith. Accordingly, when the arrangement 101 is provided with information identifying the asset, asset settings and/or asset type (e.g. email client, payment application, web server, etc.), the arrangement is configured to determine the associated risks based on risk data available (e.g. stored in a database of/available to the arrangement 101, the risk data linking asset types, specific assets and/or asset types with related potential cybersecurity (user) risks.

In addition to asset information 104, the arrangement 101 preferably further receives user information 108. The user information 108 may in the case of an organization, where different users may utilize different digital assets with different access rights, comprise information indicative of the digital assets in use by the particular user and the related level of access (access rights, features or actions available to the user, etc.). The level of access may also be indicated for instance through indicating an employee status or level in the organization. The arrangement 101 may have access to information that links such status or level data with asset information.

The user information 108 may comprise information regarding the user device 106 that is used by the user, such as the device ID, device type, operating system version, installed or available software, applications and/or services, available communication channels, and/or the location of the user device 106. A user may in some embodiments be associated with a plurality of user devices 106, any or each of which may be specified in the information 108.

Yet, the user information 108 may include sensitivity indicator or quantifier called e.g. as ALPHA in terms of digital security or cybersecurity. Such sensitivity quantifier may be separately (e.g. user-specifically or user-group such as user role-specifically) assigned to each user of an organization by the organization itself, for example.

Various constituents of the user information 108 may be received from one or more sources. At least part of the user information 108 may be received from (an electronic system such as IT system of) the target organization that the user is associated with, and/or from the user and/or the user device 106, or provided to the arrangement 101 otherwise.

The arrangement 101 may further receive other information 110, which may be again received through various sources, such as an organization, a user or user device 106, and/or a number of 3^{rd} party sources such as one or more software, service or hardware providers, cybersecurity information or service providers, etc. Other information may comprise basically any information that is considered relevant to cybersecurity from a standpoint of suggested training methodology.

For example, a cybersecurity company or in practice, its digital information provision system including e.g. a communications server, could offer indications on realized or possible attacks, viruses, malicious software, alerts, news, etc. to the arrangement 101 based on which the arrangement 101 may be configured to supplement or update its data and/or actions, including triggering of training among other options. For example, training elements, cybersecurity (user) risks, and/or digital asset risk associations could be revised based on the other information 110.

In terms of tangible examples, information on cybersecurity and/or related threats may be obtained by the arrangement 101 from third party services such as “Cyber Threat Intelligence Services” provided by FireEye™ in close to real time. Further, e.g. The National Cyber Security Centre (NCSC) of the United Kingdom Government may provide information on various computer security threats.

A target organization may be further associated with digital security sensitivity indicator or quantifier called e.g. as BETA. The quantifier may be provided by the organization itself (e.g. by electronic system of the organization), other entity or be at least partially determined by the arrangement 101 based on e.g. organization type used as input to selected sensitivity determination logic (e.g. a mapping table or logic mapping different types of organizations into a sensitivity class with certain sensitivity quantifier).

The digital asset information 104 and/or other information 110 may contain information that is common to many assets or concerns the organization in more general manner than with respect to a single asset, with reference to e.g. general authentication and/or specifically password policy (e.g. required complexity, required frequency of changes, etc.)

In various embodiments, any of the received information 104, 108, 110 may be utilized to determine user profiles associated with a user and/or organization profiles associated with an organization. The user/organization profiles may be stored in at least one repository such as a database 112.

In various embodiments, any of the received information 104, 108, 110 may be used to determine at least one risk factor for each of the digital assets that may be used by the at least one user, as will be disclosed hereinafter. The at least one determined risk factor will then be used to provide a user with tailored cybersecurity training.

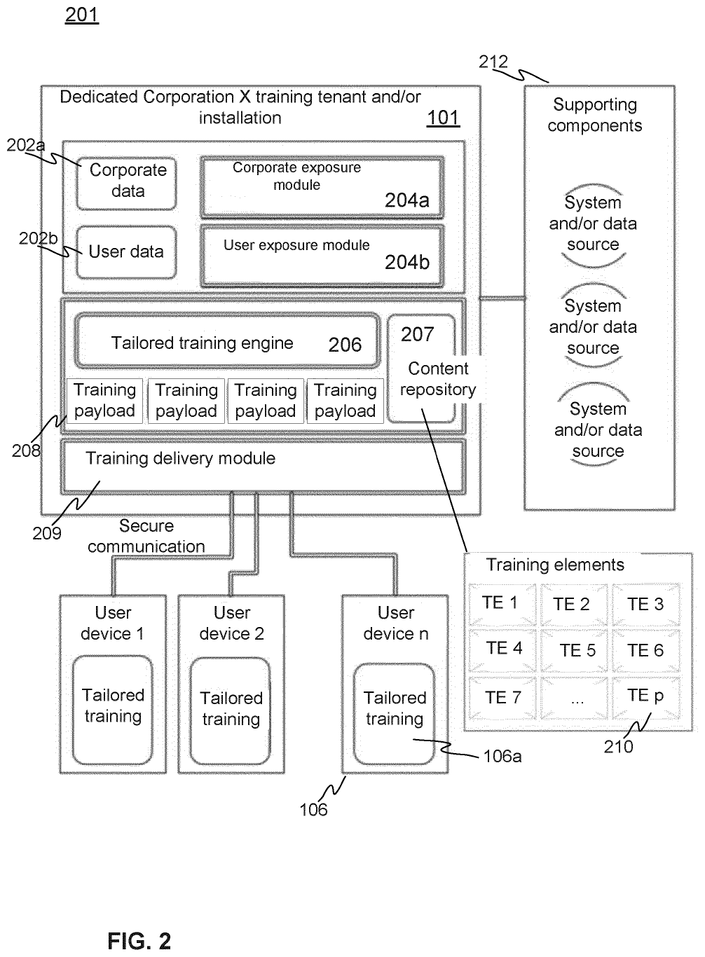

With reference to FIG. 2, an embodiment of the arrangement 101 is shown at 201 in more detail with external entities 106, 210 and related connectivity.

As described hereinbefore, organization related information 202a such as corporate identity information, asset information 104, sensitivity indicator, etc. may be obtained from various sources and/or determined based on the received data. The information 202a may be stored and maintained by the arrangement 101.

A corporate or generally organization exposure module 204a or a number of similar entities may be configured to determine organization-level exposure to digital/cybersecurity risks based on the information 202a and trigger, for example, related training when necessary.

The module 204a may be configured to determine e.g. at least one risk factor and/or whether the risk factor fulfils a predefined condition (exceeds a static or dynamically determined threshold, for instance) to trigger training and/or a number of other measures.

Yet, user(-related) information or data 202b indicative of e.g. assets used by a user, related user rights, cybersecurity risks associated with the user (these can also be determined based on the assets and related risks as contemplated hereinlater), and/or sensitivity indicator, may be further obtained through receiving such (see user information 108) and/or determining such (based on e.g. received user information and selected analysis, processing and/or mapping logic targeted to the received user information, for example). The information 202b may be stored and maintained by the arrangement 101.

A user exposure module 204b or a number of similar entities may be configured to determine user-level exposure to cybersecurity risks based on the information 202b and trigger, for example, related training when necessary. The module 204b may analyse, optionally substantially in or close to real-time, how vulnerable a user is based on selected criteria and information (user device used, used and/or accessible assets, etc.).

The module 204b may be configured to determine e.g. at least one risk factor and/or whether the risk factor fulfils a predefined condition (exceeds a static or dynamically determined threshold, for instance) to trigger training and/or a number of other measures.

A tailored training engine 206 may be configured to determine (prioritize, trigger, etc.) tailored (personalized) training 106a to users to be, preferably securely (e.g. over encrypted connection) provided by training delivery module 209 via user devices 106 equipped with more generic (e.g. web browser) or dedicated (e.g. native application) software running in the devices 106 and communicating with the arrangement 101 over suitable wireless (wireless LAN, cellular, etc.) and/or wired connections e.g. over the internet. Special software to be optionally run on the user devices 106 for delivering training may be downloaded from a digital platform such as a server-run platform operated or at least trusted by the arrangement 101, for instance, or provided on a digital carrier such as a memory card.

A content repository 207 may contain e.g. a collection of training elements 210, wherein a training element 210 (TE) is associated with at least one cybersecurity (user) risk and/or digital asset (that may in turn be associated with a plurality of cybersecurity risks as described hereinafter).

For instance, the engine 206 may be configured to select or determine most applicable training elements 210 for determining a preferred training payload 208 for a user based on the received asset, user and/or other information. The payload 208 may thus comprise a selected (sub-)set of training elements 210.

The training payload for training a user comprises a set of TEs (based initially on mapping one or more UR to one or more CA) 210 selected from the overall space of TEs in preferred order determined using a prioritization logic. A so-called impact index may be assigned to a TE 210 to indicate its importance and thus priority among multiple TEs 210. The impact index may be based on predefined configuration.

For example, if one TE 210 trains for and/or actually guides through password change and other TE 210 is about turning off wi-fi then the determined order could be to perform the one TE, as considered more important or requisite to the other, before the other TE in the training path or payload. ATE 210 may be assigned a numeric value indicative of the impact index, e.g. a value falling within a range from about zero to one (e.g. decimal number), where most impactful TE will be assigned highest number such as 0.999 and the least impactful TE lowest number such as 0.001 depending on the number of used decimals. The impact index could be adjusted by the operator of the arrangement 101 or it could be altered automatically by the arrangement 101 based on selected update logic and dependent e.g. on information received from external systems concerning e.g. high threat alerts regarding assets and/or related cybersecurity risks. The related training elements could be given more priority within the training payload by way of elevated impact index, for instance.

In some embodiments, an impact index or other indicator may be harnessed into defining training elements that, when included in a training payload of a user, have to be successfully and/or verifiably finished prior to getting access or being able to otherwise use the digital asset in question.

Generally, training may be scheduled and delivered to a user at the most convenient moment based on e.g. user schedule or calendar information provided to the arrangement 101 by the system of a related target organization or the user himself/herself via e.g. user device. In urgent cases where imminent high-level threat has been detected according to the used criterion (e.g. impact index or other indicator), training may be delivered e.g. via a push mechanism to the user/user device advantageously essentially immediately by the arrangement 101.

A similar or other type of an accelerated procedure may be applied to the aforementioned cases involving training that has to be completed prior to being able to access or otherwise utilize the digital asset in question.

Additionally, the content repository 208 may comprise e.g. graphics, audio, text and/or other data for the training.

A number of supporting components 212 refer to different data sources such as electronic systems (e.g. IT systems) of target organizations and other external systems potentially providing data input to the arrangement 101 for providing training.

Various, primarily functionally described, modules and engines reviewed herein may be practically implemented by the combination of specific software 136 and more generic hardware 102, 138 as being easily understood by a person skilled in the art, and/or by application-specific hardware, for example. Any module or engine may be practically integral with another module or engine, or split into a number of smaller entireties, if preferred in favour for optimal implementation.

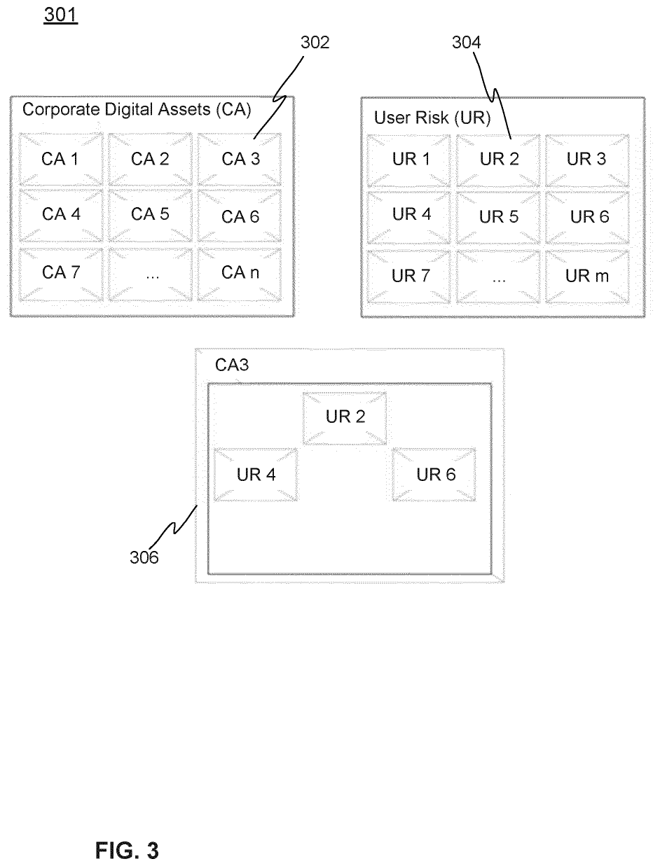

FIG. 3 illustrates at 301 an embodiment of modelling the relationship between digital assets and user risks identified by the arrangement 101, which may be utilized by the arrangement 101 in determining e.g. related risk factors to be reviewed in further detail hereinlater.

An organization such as a corporation is associated with a number of digital assets (CA, corporate assets) 302. On the other hand, a number of cybersecurity (user) risks 304, which can be instantiated based on e.g. user activity and/or passivity (lack of activity), have been generally identified and characterized in the arrangement 101, e.g. stored in a data repository. Typically, but not necessarily, each of the risks 304 is associated with at least one digital asset 302. Some risks 304 may be relevant to several assets 302.

The arrangement 101 may be configured to store or at least have access to indications of such associations 306 e.g. in the asset information in order to, for example, determine an asset-specific risk index, which may in turn be utilized to determine e.g. organization such as corporate level risk factor based on e.g. all constituent asset risk indices. Alternatively or additionally, an asset-specific risk index may be determined based on other input either automatically or manually.

As mentioned hereinbefore, a risk such as an asset risk and/or cybersecurity (user) risk may be of binary type (for example, an individual cybersecurity risk is or is not relevant to an asset). A risk may be alternatively or additionally associated with a finer scale of values, such as numerical value within a range (e.g. 0-1 with desired resolution as to the number of decimals used).

As a selected user is associated with a number of assets and each asset is associated with a number of user-related or user level cybersecurity risks, also a user is naturally associated, via the assets, with a number of cybersecurity risks. The arrangement 101 may determine such associations (user risks and/or user assets) based on the user information preferably user-specifically and/or store them e.g. in the user information, as mentioned hereinbefore.

As a tangible example, if CA3 302 represents a financial system, UR 2 304 could represent the risk of user not exiting the session (program) after performing a transaction via desktop computer browser. UR 4 could represent a risk of not closing mobile application for performing financial transactions after usage. Pertinent additional risk UR 6 could be based e.g. on some other user action or lack of action (passivity).

CAiR could represent a risk index of asset T, where CAiR could be given a numeric value falling e.g. within a range from 0 to 1. 0 could represent low risk level and 1 high risk of e.g. data breach or system potentially being vulnerable. During e.g. deployment of the asset CAiR could be assigned an initial value. CAiR may be then adapted by the arrangement 101 based on input from system administrator and/or based on the received information such as the asset, user and/or other information. For example, if it is received an indication that a specific version of the asset used by organization X has a newly exposed vulnerability whereupon potentially user ID and passwords are exposed, the arrangement 101 may update, responsive to such indication, CAiR to a higher number indicative of elevated risk, e.g. to number close or equal to 1 in the case of 0-1 overall range. Increase in the asset risk will then trigger training which covers e.g. password change.

In various embodiments, as an asset 302 is associated 306 with a number of (one or more) cybersecurity risks 304, change in any of such constituent risks based on e.g. received information or specifically indication as discussed above, may affect the risk index of the asset. The asset risk index may thus be at least partially determined based on the constituent cybersecurity risks, or values or magnitude of constituent cybersecurity risks, which may optionally further be user specific, user group specific, or general (may depend on e.g. user rights/role or used user device, related operating system, etc.).

Through utilization of the binary and/or finer (scaled) data, the arrangement 101 may then in at least some embodiments be configured to determine e.g. the aforementioned organization or corporate level overall risk index (CR). The overall index may be based on the constituent asset risk indices (risks of assets in use by the organization), optionally using arithmetic mean, weighted mean, maximum, minimum or median thereof; for example, more recent risks or other selected risks could be weighted over other risks according to selected criteria. A simple example based on arithmetic mean is given as:

$$CR = \frac{CA 1 R + CA 2 R + … + CAnR}{n} . \qquad ( 1 )$$

As mentioned hereinbefore, during e.g. initial deployment of the training service relative to an organization, the organization may be assigned a digital security sensitivity quantifier or BETA, falling e.g. within a range from zero to one (0<BETA<=1). In this example, an organization dealing with e.g. less tender or critical data, could be assigned a higher value, and vice versa (e.g. a governmental organization or private company dealing with highly secret data could be then assigned a smaller value).

In various embodiments, to trigger a training session having regard to the organization, an increase of CR may be monitored by the arrangement 101 in terms of fulfilling a triggering (training) criterion. For example, CR turning out greater than the set BETA threshold (in this example a smaller BETA indeed converts into a higher risk sensitivity, and vice versa) could be utilized by the arrangement 101 as a triggering condition to trigger training session comprising training payload with a number of training elements to e.g. users using the digital asset(s) that impacted the CR (caused the increase) or several, if not most or all, users of the organization (e.g. users using any of the assets taken into account in determining the CR as a whole). The payload and related training elements preferably address the asset(s) and/or underlying cybersecurity risks that elevated the CR to the level or beyond the BETA threshold.

Alternatively or additionally, an increase or increase greater than a selected threshold in the CR or in the risk of constituent asset, or the absolute value or level of risk associated with the asset exceeding a threshold, could trigger training with a number of training elements targeted e.g. towards users associated with the asset and/or cybersecurity risk elevated and underlying the asset.

A user risk index (URI) is preferably user-specific and can be determined based on the cybersecurity (user) risks associated with the user in question. As explained above, as each user can be associated with certain assets (based on e.g. user rights given and/or usage history monitored) and assets give rise to certain cybersecurity risks, the user can be associated with the cybersecurity risks underlying the assets.

As each cybersecurity risk associated with the asset may not or cannot however realize having regard to a certain user (if there are e.g. two mutually exclusive cybersecurity risks based on the particular operating system or other characteristic of user device used by a user, or based on the user rights of the user) not necessarily all asset-related risks are relevant or concern a single user, and may be thus omitted from determining the user-specific URI by the arrangement 101. Yet, the user risk index URI may contain further inputs or constituents based on e.g. information received from external systems or manual triggering (by operator of the arrangement 101), which may be optionally further given user-specific values or weight.

Again, a desired way to determine the risk (index) may be utilized in each embodiment with reference to e.g. arithmetic mean, weighted mean, maximum value, minimum value, and/or median of the constituent risks, for example, as discussed above relative to overall or aggregate asset risk CR.

In the light of the foregoing, user risk index UkRI of user k could be thus defined e.g. using simple arithmetic mean on constituent cybersecurity risks (values of constituent risks) 1-m that are relevant to the particular user (may realize in connection with assets used by the user, for example) as follows:

$$UkRl = \frac{UkR 1 + UkR 2 + … UkRm}{m} . \qquad ( 2 )$$

Basically, there are various different constituent factors and events that may increase the URI due to e.g. increase in the constituent relevant risks (or affecting the selection of relevant risks to a user), including e.g. internal events to the organization, external factors, user actions etc. Examples of internal events include an event where a user gets a new user device (new phone, new PC . . . ) or access to a new digital asset, for instance, or the user gets elevated rights for a particular asset.

Yet, due to e.g. changes in legislation, an organization may be obliged to perform e.g. a particular standard certification process involving or triggering cybersecurity training via the arrangement 101. Accordingly, the arrangement 101 may be provided an external input to execute trainings having regard to all or selected topics. A user risk potentially affecting a particular user risk index and/or triggering training procedure(s) could also be based on a lack of training (no registered proof of training underwent) having regard to some selected topic such as asset or cybersecurity risk associated with the asset available to the user.

Examples of external factors or signals elevating the URI and/or triggering the training include e.g. received information about company increased exposure to cyber risk. For example, information is retrieved from an external source such as dark web, according to which organization assets or related data, such as email UserIDs and Passwords of employees working in R&D department, have been compromised. As a reactive measure, training involving real password change could be triggered to all relevant users (e.g. users having an email account in this scenario). Another triggering input could be based on receipt of information from external system according to which a cybersecurity attack is executed or planned against the organization. Such input may be based on machine learning and/or automated data mining procedures exploiting crawler technology, for instance.

A further input could indicate a found and publicly announced security flaw or bug in a digital asset such as software or hardware utilized by the organization. An example of user action is e.g. detected user-triggered installation of a new application in a user device, which may raise security concerns and even trigger a training procedure during which the application shall be deleted or related application-issued rights towards the device reduced.

In various embodiments, to trigger a training session having regard to a selected user, the URI of the user may be monitored by the arrangement 101. Upon any increase of the URI or increase high enough according to a utilized criterion, or the URI increasing to a level or beyond a selected threshold, the arrangement can identify the constituent risk(s) that impacted the increase.

For instance, as deliberated hereinbefore, during e.g. deployment of the training service, each user could be assigned with digital security sensitivity indicator or quantifier ALPHA, where its numerical value could fall within a selected range of e.g. 0<ALPHA<=1. The lower the ALPHA, the more risk sensitive the user is. For example, corporate executives, R&D personnel, system administrators could be assigned lower values (either by the target organization or by the arrangement based on e.g. role-value mapping logic or table) while e.g. a summer trainee with no access to any confidential information could have very high value such as a value equal or close to one associated therewith.

An increase of URI greater than ALPHA as determined by the arrangement 101 could be converted into triggering tailored training session to address the cybersecurity risk associated with the increase, for example.

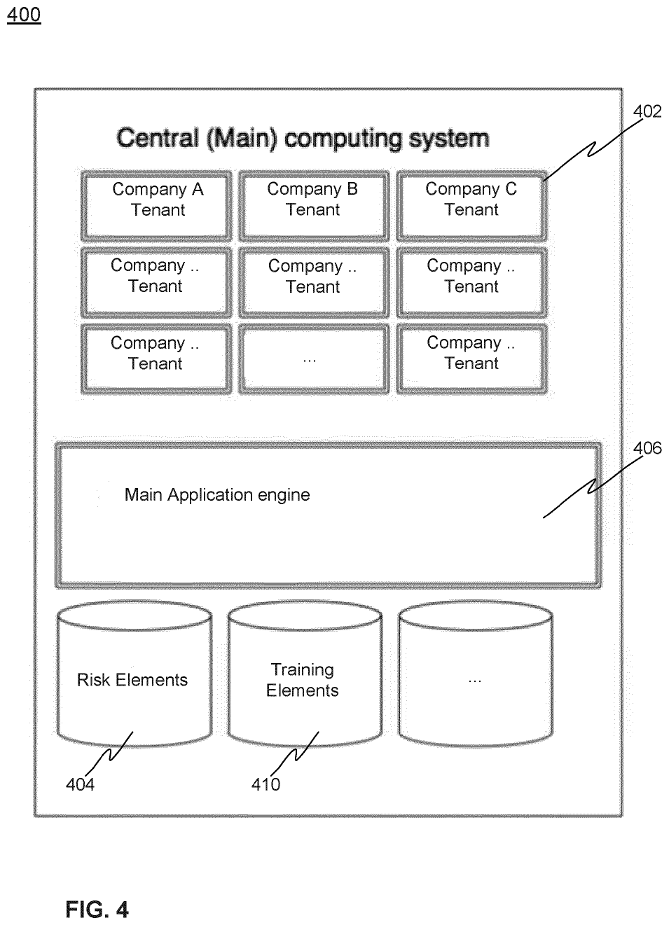

FIG. 4 illustrates at 400 an embodiment of the arrangement 101 from the standpoint of serving a number of clients (target organizations for training operations) and storing related information.

Regarding a certain target organization such as company or corporation 402, related data may be, preferably at least partially anonymously, stored in the memory of the arrangement 101, still possibly distributed among data of other target organizations but nevertheless identifiable using anonymous identification data stored therewith. The data may include asset information including e.g. inventory of digital assets within the scope of training procedures, user information and various other information regarding the organization as discussed hereinbefore. Yet, the arrangement has access to data collections 404, 410 regarding cybersecurity risks, training elements, and related data elements such as associations between different risks and assets.

During establishing a “tenant” profile of an organization in the arrangement 101 either by the operator of the arrangement 101 using e.g. suitable UI features and/or the arrangement 101 itself based on automated analysis of the received information by analysis logic, digital assets of the organization may be identified, classified and/or associated with risks 404 and/or training elements that may be of more general use (not exclusively related to any single organization only). The arrangement 101 may comprise machine learning logic and/or other logic to determine vulnerabilities or risks associated with different assets or asset types based on e.g. available determination or mapping logic. These logics may come in various resolution having regard to e.g. versions of digital assets (e.g. software version of asset, which may have effect on the related risks, etc.). Subsequently, information regarding the organization may be supplemented or updated based on executed training sessions (based on which e.g. risks associated with lack of training may be automatically lowered by the arrangement according to selected logic), external information (e.g. vulnerability/threat or other risk data obtained), and/or control input from the operator of the arrangement 101 or the organization.

Main Application Engine 406 may perform or facilitate the various determining, analysis, and/or logic tasks associated with the operation of the arrangement 101.

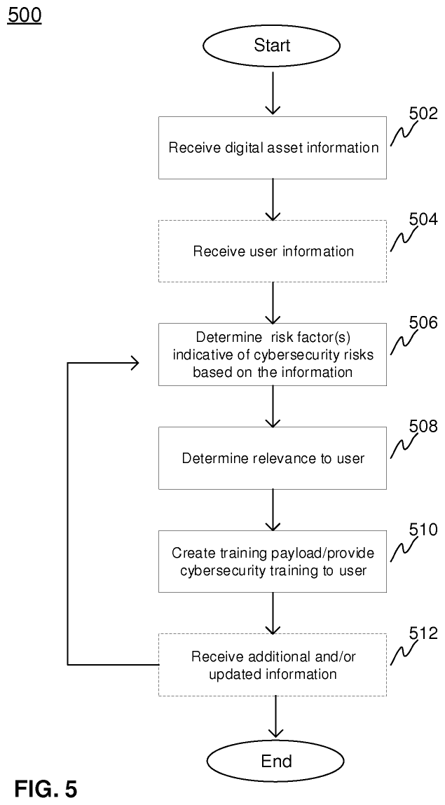

FIG. 5 shows, at 500, a flow diagram regarding an embodiment of a method in accordance with the present invention for providing e.g. a number of organizations with tailored cybersecurity training, wherein a number of users are associated with an organization and wherein each user of the number, typically plurality, of users is associated with at least one electronic user device.

At start-up, the method may be ramped up by provision of necessary hardware and software, for instance, using at least one server computer or e.g. a cloud computing platform or other system comprising a plurality of servers. The necessary communication connections may be established or tested.

At 502, asset information related to a plurality of digital assets that are available for use for one or more of the number of users associated with the organization is received as discussed hereinbefore. The asset information may identify and/otherwise characterize the assets, for instance.

At 504, user information as e.g. contemplated hereinbefore is received regarding a user, preferably each user, of the number of users.

The user information may indicate user such as access rights having regard to digital assets and e.g. user device related data, regarding a user (preferably defined for each user separately depending on the desired processing resolution as discussed hereinlater).

At 506, based on the received information (asset, user and/or other), at least one risk factor such as any of the aforementioned CR (index), URI and/or individual asset risks is determined. As described hereinearlier, these are related to assets and cybersecurity (user) risks concerning the assets.

At 508, the relevance of the at least one risk factor and/or associated digital asset to a particular user is determined, with reference to above-discussed CR, URI, asset risks and/or user risks, for example. Yet, threshold values such as the aforementioned ALPHA and/or BETA may be exploited in the relevancy assessment as reviewed herein. As being further disclosed, not all assets or associated cybersecurity risks necessarily concern each user, whereupon even considerable increase of a risk not relevant to a user e.g. in the context of an asset may not require triggering any related additional training to the user either. The relevance determination may yield binary type (is relevant/is not relevant) output, for example.

Here or e.g. during the subsequent step, also the mutual order of potentially multiple training elements to be delivered in the training payload to the user is determined based on e.g. impact indexes as discussed hereinbefore.

Accordingly, at 510, based on the determined relevance, the user is provided with cybersecurity training based on the established training payload of one or more training elements, preferably covering the cybersecurity risk(s) underlying the risk factor and/or asset considered relevant via the electronic user device. The training is preferably delivered in the (temporal and/or spatial (UI)) order of decreasing importance or impact, or at least such order is signalled to the user via the UI of a training application as discussed hereinlater, or in some other order e.g. technically necessitated by the training topics. The training may optionally include instructed execution of cybersecurity enhancing or securing tasks, such as password changes, service or application settings modifications, or application deletions, instead of or in addition to “mere” information channelling to the user. Also these aspects are considered in more detail hereinlater.

Item 512 refers to receipt of additional or updated information from the systems of target organizations or third parties, whereupon risk factors may be re-calculated and new training operations determined and triggered to selected users or the organizations as a whole as analysed hereinbefore.

As user information preferably contains user-specific information, items 506-512 are advantageously determined separately for each user subjected to potential cybersecurity training procedures in the organization (preferably at least all such users having some access to confidential digital information, for instance) in order to provide tailored training on user, not just organization, level. In some embodiments, one or more risk factors such as the aforementioned CR may, however, basically be user-independent and calculated collectively regarding all or at least a plurality of users, whereupon their determination may be fully executed only once for such users, for example, instead of separately calculating them for each user and thus repeating the same calculations. Thus, even though risk factors are to be determined for each user, the underlying calculations do not have to be unnecessarily repeated, when such repetition is easily avoidable.

In some embodiments, a “user” could refer to a user class, role or user group, potentially including a plurality of users with e.g. similar profile and/or similar rights in terms of e.g. digital assets, whereupon also related determinations and actions underlying e.g. any or all of items 506-512 could be executed user class, role or group specifically instead of actual single user (person) resolution in favour of e.g. technical process efficiency (reduced usage of memory, communication and/or processing resources). Even in such embodiments, some individual users (persons) could be still considered independently.

It shall be mentioned here that the arrangement may be configured to collect information from various sources and utilize it collectively. For example, if e.g. systems of one of the target organizations provide the arrangement with threat or risk information regarding some asset, the information may be advantageously utilized by the arrangement also in favour of enhancing the security of other target organizations, and vice versa. Such feature may be made adjustable, based on e.g. permission input by the source organization.

Likewise, the arrangement may be configured to execute selected methods of analytics and/or machine learning on data obtained from or regarding only certain sources or targets such as organizations to detect patterns, identify existing or arising cybersecurity risks, execute pre-emptive or corrective (training) measures etc. Accordingly, the results may be exploited more broadly among the target organizations to enhance the security of e.g. all organizations served.

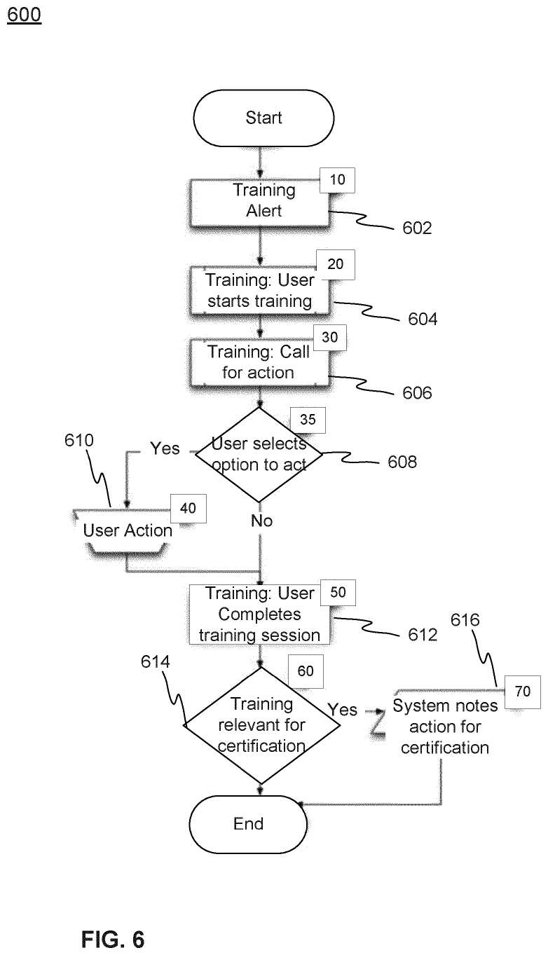

FIG. 6 shows, at 600, a flow diagram of an embodiment of cybersecurity training delivery process towards one or more users (e.g. employees) of a target organization.

At 602, a user to be trained has been provided with access to a mobile or other user device on which she/he receives a notification (training alert) from an electronic training arrangement about pending training. In case the user has installed e.g. a training (client) application the alert can be conveniently received as a push message. In other scenario the alert could be received as a text message or other message with a link (e.g. URL) whose selection will open or initiate a tailored training session, for instance. Still, the alert could be sent e.g. as an email with the link selection of which opens the tailored training session (20) within a generic application such as internet browser (e.g. in the case user has no installed training application.

At 604, the user starts or initiates the execution of the training session. For example, the training session may provide information on a topic of a concerned training element regarding some asset and/or related cybersecurity risk. Additionally or alternatively, the session may be configured by the training arrangement to guide the user to perform related cybersecurity enhancing measure(s). For example, the information and/or measure could be about turning on additional security layer in connection with Multi-Factor Authentication (MFA) at least for selected transactions such as financial transactions or other transactions of considered high value to the organization.

Optionally, the training session controlled by the arrangement explains or guides e.g. in step-by-step fashion actions needed by the user to execute a desired action, for instance, to enable the MFA in the above example. The arrangement is preferably aware of various information to optimize the training, e.g. exact version of the financial system and exact UI of the user device, and thus capable of providing the training content in the form of a ‘guided tour’ on how action needs to be executed. After providing first selected (e.g. motivational, background and/or how-to) information e.g. in text, graphical, audio and/or video format to the user, the user may be requested by the training application to actually act, at 606, and execute the needed measures, in this case enabling e.g. the MFA as per instructions. The request may be textual, graphical, and/or comprise video and/or audio.

The user may be prompted to perform action(s) or complete the training without acting, the potential availability of actual choice provided to the user depending on the nature of the training (dependent on e.g. underlying risk and its priority or type). The user may thus select the option to act or otherwise proceed with the training via the user device/training application at 608.

In the case of training necessitating user action, the user performs requested action at 610, preferably monitored and verified by the arrangement based on e.g. data provided thereto by the user device and/or system of the target organization or other entity wherein a related change or result underlying the action is detectable and returns to the training application to complete the training session 612. Indication of a successfully executed user action may be stored by the arrangement. In the case of no action e.g. within a selected time period, the arrangement may be configured to additionally instruct or remind the user by e.g. a message via the user device and e.g. training application therein (or using other/general notification mechanism of the user device).

In some embodiments, a training session may be a (necessary) part of a certification process 614, which will be noted for the record e.g. having regard to the stored user information/profile and/or organization information/profile at 616. Instead of or in addition to a digital certificate, other indication of performed training may be created and stored by the arrangement. The certificate regarding the training may be requested e.g. from a certificate issuing (external) system or directly issued (created or associated) to the user and/or associated organization by the arrangement. The certificate may be communicated to the user/user device and/or system of the related organization.

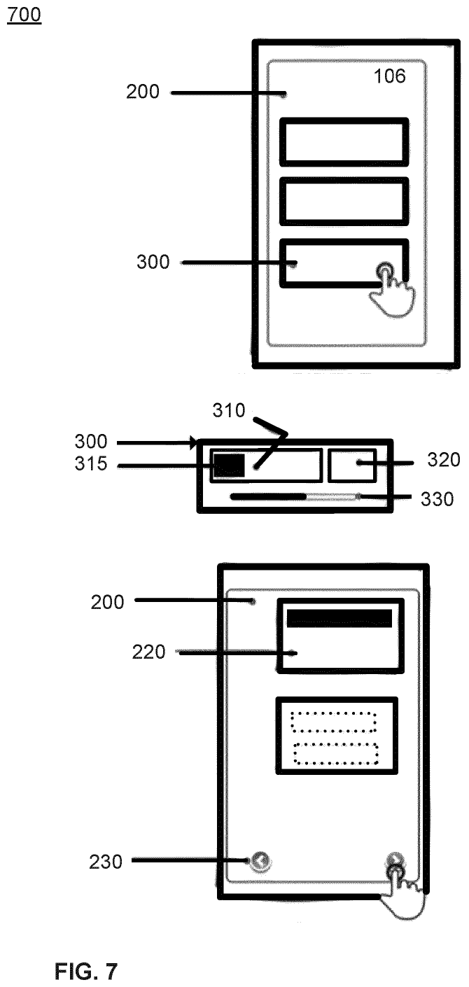

In FIG. 7, few high-level examples of user interface(s) and related features for delivering training via a user device 106 are provided at 700, 720 and 740.

A user device 106, or in this example, a specifically mobile user device has been advantageously provided with a training application (a dedicated client app or e.g. browser based) 200. The training application may arrange and indicate preferably visually or graphically, using e.g. graphical symbols, a number of training modules 300 to be selected and completed by a user.

A training module 300 may have information such as a training title and/or description indicated 310 e.g. via a display of the user device, optionally being of touch sensitive type.

The training module 300 may refer to or be associated with a training element or a plurality of training elements regarding a common topic such as common digital asset, for example.

Item 315 refers to an urgency indicator. It may indicate, by e.g. symbol, text, number, color and/or pattern, the priority and/or relevance of training modules to the user, based, for example, on their impact indices discussed hereinbefore. Alternatively or additionally, ordering of data such as modules or related training elements e.g. on a display may be configured to indicate their urgency or relevance.

Item 320 refers to an indicator, such as the one defined above, having regard to whether user action(s) (measure(s) to be executed by the user) are needed in connection with (during or (immediately) responsive to) the training. For example, if a training module is about password change, the indicator 320 could show whether user password has to be changed.

Item 330 refers to an indicator (e.g. a graphical bar, numeric indicator such as percentage, etc.) showing the progress within a selected training module or concerning several training modules, e.g. all training modules available or targeted to the user.

At 740, item 220 represents a content item e.g. within or associated with a training module 300. The item 220 may comprise e.g. text, image, other graphics and/or video.

Item 230 refers to one or more navigational or other control (input) items such as icons or other graphical items that may be functionally connected to the training application and/or related training module so that the current display view may be altered. A user may be enabled to navigate through the training application or e.g. training module, or between modules, thereof by touching or swiping item(s) 230, for instance.

The invention has been explained above with reference to the aforementioned embodiments, and several advantages of the invention have been demonstrated. It is clear that the invention is not only restricted to these embodiments, but comprises all possible embodiments within the spirit and scope of inventive thought and the following patent claims.

The features recited in dependent claims are mutually freely combinable unless otherwise explicitly stated.

1. An electronic arrangement for providing a number of organizations with tailored cybersecurity training, a number of users being associated with an organization and each of the number of users being further associated with an electronic user device, the arrangement comprising a data interface and at least one processor that is configured, in accordance with instructions stored in a memory accessible to the at least one processor, to
receive asset information related to a plurality of digital assets that are available for use for one or more users of said number of users associated with the organization, and preferably for each user of said number of users associated with the organization:
receive user information related to a user,
determine, based on the received information, at least one risk factor that is indicative of a cybersecurity risk related to use of at least one of the digital assets,
determine, based on the received information, the relevancy of the at least one risk factor and/or associated at least one digital asset to the user, and
based on the determined relevance, provide the user with cybersecurity training (106a) targeting the cybersecurity risk via the electronic user device.

2. The arrangement of claim 1, wherein the user information may indicate at least one element selected from the group consisting of: cybersecurity sensitivity indicator, access or generally user rights associated with a digital asset, type and/or properties of user devices in use, applications and/or operating systems installed in a user device, and data regarding usage of a digital asset, such as spatial and/or temporal usage history, by the user.

3. The arrangement of claim 1, wherein a plurality of cybersecurity training elements is provided as training payload during the cybersecurity training, each being associated with at least one cybersecurity risk and/or digital asset associated with a number of cybersecurity risks, and providing the user with cybersecurity training comprises selecting one or more of the cybersecurity training elements from the group of cybersecurity training elements and providing the selected cybersecurity training elements to the user.

4. The arrangement of claim 1, wherein a plurality of cybersecurity training elements is provided as training payload during the cybersecurity training, each being associated with at least one cybersecurity risk and/or digital asset associated with a number of cybersecurity risks, and providing the user with cybersecurity training comprises selecting one or more of the cybersecurity training elements from the group of cybersecurity training elements and providing the selected cybersecurity training elements to the user and wherein the cyber security training elements are provided to the user in a determined order

5. The arrangement of claim 1, wherein a plurality of cybersecurity training elements is provided as training payload during the cybersecurity training, each being associated with at least one cybersecurity risk and/or digital asset associated with a number of cybersecurity risks, and providing the user with cybersecurity training comprises selecting one or more of the cybersecurity training elements from the group of cybersecurity training elements and providing the selected cybersecurity training elements to the user and wherein each cyber security training element is assigned an impact index and providing the user with cybersecurity training comprises providing the cybersecurity training elements to the user in an order that is based at least on the assigned impact indices.

6. The arrangement of claim 1, wherein the at least one risk factor comprises at least one asset risk index that is associated with a digital asset, said asset risk index optionally being user independent or dependent.

7. The arrangement of claim 1, wherein the at least one factor comprises at least one asset risk index that is associated with a digital asset, said asset risk index optionally being user independent or dependent and wherein at least one of the at least one asset risk indices is set and/or updated based on at least one element selected from the group consisting of: predefined selection, type of asset such as type of related digital service, at least one cybersecurity risk associated with the asset, value of at least one cybersecurity risk associated with the asset, type of cybersecurity risk associated with the asset, asset version and asset vulnerability data.

8. The arrangement of claim 1, wherein the at least one risk factor comprises at least one asset risk index that is associated with a digital asset, said asset risk index optionally being user independent or dependent and wherein the at least one risk factor comprises an organization-digital asset risk index that is indicative of an overall or combined risk concerning a plurality of digital assets associated with the organization and is determined based on the asset risk indices

9. The arrangement of claim 1, wherein the at least one risk factor comprises at least one asset risk index that is associated with a digital asset, said asset risk index optionally being user independent or dependent and wherein the at least one risk factor comprises an organization digital asset risk index that is indicative of an overall or combined risk concerning a plurality of digital assets associated with the organization and is determined based on the asset risk indices, further wherein the organization digital asset risk index is based on the constituent asset risk indices, preferably arithmetic mean, weighted mean, maximum, minimum or median thereof.

10. The arrangement of claim 1, wherein the at least one risk factor comprises a user risk index that is associated with a user, preferably being determined user-specifically and optionally based on values of constituent cybersecurity risks, preferably arithmetic mean, weighted mean, maximum, minimum or median thereof.

11. The arrangement of claim 1, wherein the arrangement is configured to receive information related to a plurality of organizations and their respective users and digital assets, and utilize the information in providing the users with tailored cybersecurity training.

12. The arrangement of claim 1, wherein the at least one risk factor is assigned an initial value and the value is updated upon the arrangement receiving additional and/or updated information and the providing of the cybersecurity training is updated accordingly.

13. The arrangement of claim 1, wherein the providing of cybersecurity training is initiated automatically according to a number of predetermined criteria.

14. The arrangement of claim 1, wherein the providing of cybersecurity training is initiated automatically according to a number of predetermined criteria and wherein the predetermined criteria comprises the at least one risk factor being updated so that the change in the risk factor exceeds a predetermined value. exceeding a predetermined value or the at least one risk factor being updated so that the change in the risk factor exceeds a predetermined value.

15. The arrangement of claim 1, wherein the providing of cybersecurity training is initiated automatically according to a number of predetermined criteria and wherein the predetermined criteria comprises the at least one risk factor exceeding a predetermined value or the at least one risk factor being updated so that the change in the risk factor exceeds a predetermined value, further wherein the predetermined value comprises or is based on at least one indication selected from the group consisting of: organization digital security sensitivity, and user digital security sensitivity.

16. A method for providing a number of organizations with tailored cybersecurity training, a number of users being associated with an organization and each of the users being further associated with an electronic user device, the method comprising:
receiving asset information related to a plurality of digital assets that are available for use for at least one of the users
preferably for each user:
receiving user information related to a user,
determining, based on the received information, at least one risk factor that is indicative of a cybersecurity risk related to use of at least one of the digital assets
determining, based on the received information, if the at least one determined risk factor and/or associated digital asset is relevant to the user, and
based on the determined relevance, providing at least one user with cybersecurity training targeting the cybersecurity risk via the electronic user device.

17. The method of claim 16, comprising triggering a notification to the user about available cybersecurity training.

18. The method of any of claim 16, comprising transmitting a request for action to the user, preferably comprising instructions on how to execute the action, and preferably further comprising determining whether the action was performed or not, wherein performing the action is part of the training and preferably involves execution of a security measure that reduces the cybersecurity risk.

19. The method of any of claim 16, comprising storing an indication of a completed training session regarding the user in a digital data repository, optionally a database.

20. A computer program product comprising computer readable instructions configured, when run on a computer, to execute method items of any of claim 16.

21. A non-transitory carrier medium comprising the computer program product of claim 20.
